(19) United States
(12) Patent Application Publication
(10) Pub. No.: US 2025/0005207 A1
(43) Pub. Date: Jan. 2, 2025

(54) Electronic Data Processing Device

(71) Applicant: Infineon Technologies AG, Neubiberg (DE)

(72) Inventors: Berndt Gammel, Markt-Schwaben (DE); Florian Mendel, München (DE); Bernd Meyer, München (DE)

(21) Appl. No.: 18/750,318

(22) Filed: Jun. 21, 2024

(30) Foreign Application Priority Data
Jun. 28, 2023 (DE) 102023117029.5

(51) Int. Cl. G06F 21/72; G06F 21/12; G06F 21/56

(52) U.S. Cl. CPC G06F 21/72; G06F 21/12; G06F 21/565

(57) ABSTRACT

One exemplary embodiment describes an electronic data processing device comprising a memory configured to store encrypted program code for a cryptographic algorithm, a cryptoprocessor unit having a security processor, an interface to the memory, an internal volatile memory and a crypto function circuit, a data processing circuit having an interface to the cryptoprocessor unit, and a path selection circuit which is configured, in a configuration state, to provide a first data path from the memory, via the crypto function circuit, to the internal volatile memory of the cryptoprocessor unit and, in an execution state, to interrupt the first data path and to provide a second data path between the security processor and the internal volatile memory and the crypto function circuit.

### TECHNICAL FIELD

This disclosure is generally related to electronic data processing devices, and is more particularly related to the handling of encrypted program code for cryptographic algorithms.

### BACKGROUND

Electronic data processing devices that process secure data, such as cryptographic keys, should be protected against an attacker gaining access to the secure data. Since protection against attacks is complicated, it is possible to provide only a specially protected part of the data processing device, a so-called secure enclave, which works with the secure data. A secure enclave denotes a domain of system resources that is enclosed by a pervasive security area in which these system resources are protected from physical and/or logical attacks from outside the domain (the unsecured area). However, in many applications, it is desirable for data to be transmitted to the secure enclave from outside the secure enclave (and thus from an unsecured or at least less secure area (with regard to certain attacks)) (e.g. for updating a cryptographic algorithm to be executed by the secure enclave or keys used by it), which can compromise the security of the secure enclave. Procedures are desirable to ensure the security of the secure enclave even in such a context.

### SUMMARY

One embodiment provides an electronic data processing device comprising a memory configured to store encrypted program code for a cryptographic algorithm, a cryptoprocessor unit having a security processor, an interface to the memory, an internal volatile memory and a crypto function circuit, a data processing circuit having an interface to the cryptoprocessor unit, wherein the cryptoprocessor unit is configured:
in a configuration state, to receive the encrypted program code from the memory, to decrypt it by means of the crypto function unit and to verify the integrity and/or authenticity of the decrypted program code and to store it in the internal volatile memory;
in an execution state, to execute the decrypted program code by means of the security processor and at least partially by means of the crypto function circuit.

The electronic data processing device in this example embodiment further comprises a path selection circuit, which is configured, in the configuration state, to provide a first data path from the memory, via the crypto function circuit, to the internal volatile memory of the cryptoprocessor unit and, in the execution state, to interrupt the first data path and to provide a second data path between the security processor and the internal volatile memory and the crypto function circuit.

### BRIEF DESCRIPTION OF THE FIGURES

The figures do not reflect actual proportions but are intended to be used to illustrate principles of the various exemplary embodiments. Various exemplary embodiments are described below with reference to the following figures.

FIG. 1 shows an electronic data processing device.

FIG. 2 shows a state diagram for the secure authenticated loading of data for one or more algorithms for a cryptographic protocol into a secure enclave memory and the execution of the program code in the secure enclave.

FIG. 3 shows a secure enclave in greater detail and illustrates how it communicates with a data processing circuit, one or more memories, and one or more peripheral devices.

FIG. 4 shows an architecture of a secure enclave according to one embodiment.

FIG. 5 shows an electronic data processing device according to one embodiment.

### DETAILED DESCRIPTION

The following detailed description refers to the enclosed figures which show details and exemplary embodiments. These exemplary embodiments are described in such detail that a person skilled in the art can carry out the invention. Other embodiments are also possible and the exemplary embodiments may be modified in structural, logical and electrical terms without departing from the subject matter of the invention. The different exemplary embodiments are not necessarily mutually exclusive but different embodiments can be combined with each other, so that new embodiments arise. For the purposes of this description, the terms “linked”, “connected” and “coupled” are used to describe both a direct and an indirect link, a direct or indirect connection, and a direct or indirect coupling.

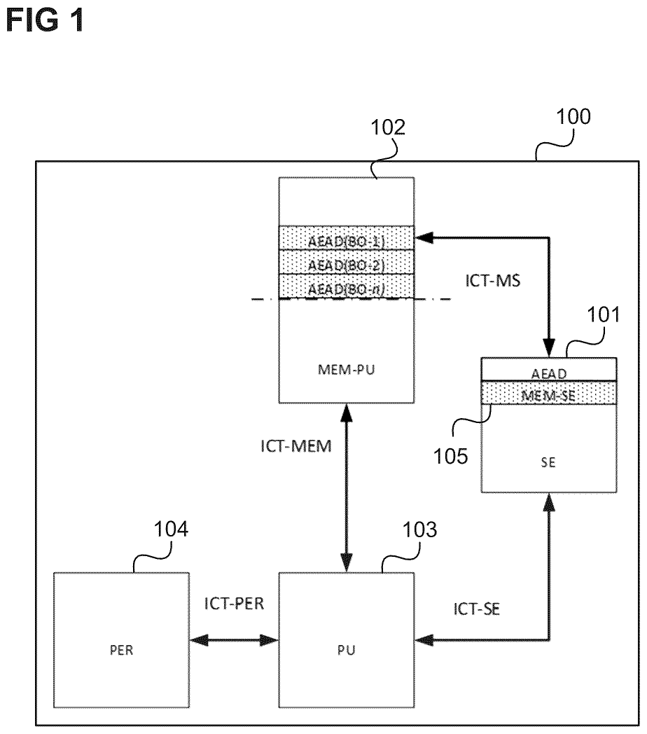

FIG. 1 shows an electronic data processing device 100 which in particular has a secure enclave (SE) 101.

The data processing device 100 may be a security controller, such as an ECU (electronic control unit) in a vehicle or a chip card with any form factor. However, the data processing device may also be a computer (or part of it), a smartphone, a tablet, etc.

The data processing device 100 further comprises a memory 102, a data processing circuit 103 (or a plurality of data processing circuits) and one or more peripheral devices 104.

A secure enclave 101 can be considered a group of system resources that operate in the same security domain and share the protection of a single, common, end-to-end security perimeter. The secure enclave 101 implements a cryptoprocessor unit.

For example, the secure enclave 101 encapsulates secret data such as secret keys (with respect to the other components 102, 103, 104, for example root-of-trust, encryption, and signature keys) and provides the data processing circuit 103 with algorithms for cryptographic protocols that use these secret data (for example these keys). This includes, for example, one-sided or mutual authentication protocols, signature creation such as ECDSA (Elliptic Curve Digital Signature Algorithm), key derivation or encapsulation, etc. The secure enclave 101 can also control the state and behavior of the system in which it is embedded, in this case the data processing device 100, by activating or deactivating security functions provided by the system.

The secure enclave 101 can contain, for example, hardware implementations of cryptographic primitives such as block ciphers (AES, . . . ), hash functions (SHA-2, SHA-3, . . . ), AEAD schemes (ASCON, . . . ), acceleration modules for elliptical curves and RSA, post-quantum algorithms (Kyber, Dilithium, . . . ) as well as software implementations of various algorithms for different protocols. Software implementations of such algorithms can run on a special processor or type of programmable state machine embedded in the secure enclave 101. The idea of the paradigm of processing using a secure enclave can be seen in that secret data never leave the secure enclave and all calculations with such secret data also take place within the secure enclave 101, with the result that the secret data are never exposed to the “outer” system domain, i.e. the domain outside the secure domain of the secure enclave. The implementation of the secure enclave usually provides a higher level of hardware security mechanisms and attack sensors compared to the system domain. The system domain, which is typically considered non-secure, includes in the example from FIG. 1 the data processing circuit(s) 103, the memory 102, and the peripheral devices 104. The secure enclave is isolated from the system domain in such a way that, even if an attacker gains control of the system domain or is able to read code and data from the system domain, the data in the SE are not compromised. In addition to keys, these data can also include useful data that is worth protecting and code that is worth protecting (e.g. implementing a special algorithm that is to be kept secret).

In FIG. 1, data paths are denoted ICT-X, where ICT-X stands for “Interconnect to X”.

When implementing an (ideal) secure enclave in practice, the following requirements typically exist:
Secret data (e.g. keys, certificates, algorithms, . . . ) must be loaded into the secure enclave. Often this information must be chip-specific. For example, not every security application allows on-chip key generation or the implementation of a hardware PUF (Physically Unclonable Function) in the secure enclave in order to provide chip-specific keys (or chip-specific key material, i.e. key information).
Flexibility is typically required with regard to the algorithms used by the secure enclave, i.e. after the hardware has been manufactured and used, repeated exchange of the algorithms (and thus e.g. supported protocols) should be possible: The reason may be
   the provision of security upgrades (after manufacturing and personalization, i.e. “in the field”, for example),
   cost savings, such as the provision of different algorithms for different markets: In this case, for example, the same hardware is used for multiple markets and the application-specific (e.g. market-specific) algorithms are inserted into the secure enclave. This is more cost-effective than implementing all algorithms and selecting only the required algorithms in the field.
Flexibility requirements, such as for the algorithms, may also exist for secret data (such as keys, etc.), i.e. it may be necessary for such data to be able to be exchanged, depending on the application.
If the secure enclave 101 has no (or insufficient) own (i.e. internal) non-volatile memory (NVM), but only (sufficient) volatile memory, (possibly chip-specific) algorithms and/or secret data from the system domain must be loaded into the volatile memory (i.e. typically a RAM) of the secure enclave.

The common feature of all these requirements is that algorithms and secret data to be loaded into the secure enclave must be authentic, confidential and protected in terms of their integrity (and accordingly require protection against logical attacks (LA) and, in many cases, also against physical attacks (PA) on the system domain side, depending on the system).

One possible way of ensuring this would be to extend the higher security level required for the secure enclave to the entire system, including all hardware and software, e.g. by using a security controller for the entire system. However, such a security controller typically lacks computing power and memory size as well as communication interfaces required for many IoT (Internet of Things) or high-end applications.

Various embodiments provide an approach that allows the above requirements (in terms of flexibility and security) to be met.

As illustrated in FIG. 1, the secure enclave contains internal memory 105 (MEM), referred to as SE memory 105 below. The SE memory 105 contains volatile memory, but can also include non-volatile memory (i.e. the SE memory 105 can be implemented by way of a memory, i.e., a memory circuit, having different memory areas (e.g. chips) which are implemented by means of different memory technologies). As described above, the secure enclave is connected to the data processing circuit 103 (PU) via a data path ICT-SE and is connected to the memory 102 (external to the secure enclave) via a data path ICT-MS. The data paths ICT-SE and ICT-MS do not necessarily need to be implemented by separate connections, but can also be implemented by means of a single (common) connection.

Public data, private keys and executable code, which must be downloaded to the SE memory 105 from the memory 102 (which can be considered to be the memory of the data processing circuit 103 and is therefore also referred to as PU memory 102 below for better differentiation) in order to implement a specific (cryptographic) protocol, are grouped into binary objects (BO).

Multiple BOs can be stored in the PU memory 103 in order to support different protocols. A mechanism is provided to protect the confidentiality and integrity of the BOs. For example, the BOs are stored in the PU memory 102 under the protection of AEAD (Authenticated Encryption with Associated Data). AEAD enables confidentiality and integrity protection in one step. Confidentiality and integrity can also be verified separately. This means that the confidentiality of each BO is protected by encryption and the integrity and authenticity are protected by a test value and the BO can (optionally) contain associated data.

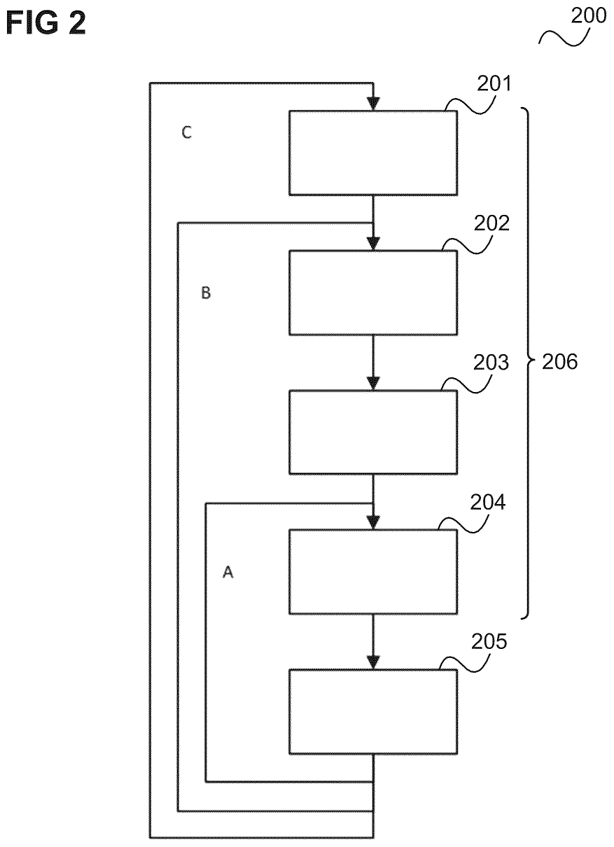

FIG. 2 shows a state diagram 200 for the secure authenticated loading of data (incl. program code) for one or more algorithms for a cryptographic method, e.g. protocol, (e.g. encryption, authentication . . . ) into the SE memory 105 and the execution of the program code in the SE.

The state diagram 200 contains five states 201-205. The operations performed in each of the states and the transitions between the states are implemented and controlled by a state machine implemented in the secure enclave 101 (e.g. FSM (Finite State Machine)). The SE is controlled via commands (hardware signals), in particular from the data processing circuit 103. The first four states are also considered sub-states of a set-up state 206 (or “configuration” state or “preparation” state) that is followed by the execution state 205.

When starting the data processing device 100 (or at least the secure enclave 101), the secure enclave 101 is in an initial state 201 (first state), or “empty” state, i.e. no BO is installed in the SE memory 105.

The data processing circuit 103 can trigger the loading of a BO in order to install and ultimately execute program code for one or more algorithms for a desired method (e.g. protocol) in the secure enclave 101. To do this, it sends a “load key” command to the secure enclave (via ICT-SE). This puts the SE into a second state (key loading state) 202 in that it expects the transmission of a key modifier (via ICT-SE) which is needed to decrypt the BO. Once it has received the key modifier, the secure enclave can derive an authentication key K-AUTH from the key modifier K-MOD and an (SE) internally available root secret K-ROOT:

$$K - AUTH = kderiv ( K - MOD , K - ROOT ) .$$

K-ROOT can be a key generated, for example, by a PUF (physical unclonable function) of the secure enclave, or a key that has been introduced into the secure enclave 101 during a personalization phase.

The data processing circuit 103 then sends an “install” command to the secure enclave 101 which puts it into a third state (install state) 203. The data processing circuit 103 then transmits the data of the e.g. AEAD-protected BO (or a BO protected with regard to confidentiality and integrity by means of another mechanism), i.e. AEAD (BO), via ICT-MS (or ICT-SE if there is only one connection) to the SE memory 105. The encrypted data are decrypted by an AEAD module (generally a cryptoprocessor unit; AEAD is used here as an exemplary embodiment) containing the SE (which may be a hardware module or software). The AEAD (BO) data contains a test value (usually after the last data word). After receiving the data, the AEAD module of the secure enclave 101 uses this test value to check whether the BO is authentic. If this is not the case, the secure enclave 101 switches to a safe state, deletes the BO from its memory, for example, and switches to the initialization state 201 (or a separate error state). If the authentication check of the BO is successful, the secure enclave switches to a fourth state (ready state or standby state) 204 and is ready to execute the program code contained in the BO for the one or more algorithms for the protocol.

If the data processing circuit 103 then sends protocol-specific input data to the secure enclave 101, e.g. via IC-SE or a separate communication data buffer, and if it starts the execution of the one or more algorithms by means of an execution command to the secure enclave 101, the secure enclave 101 switches to a fifth state 205 (execution state) and executes the one or more algorithms.

After the execution of the one or more algorithms for the protocol has been completed, the secure enclave 101 returns to the fourth state 204 (standby) and waits for a restart (path A in FIG. 2). The alternative path B switches to the second state (load key) so that another BO can be loaded, e.g. according to another protocol or a continuation of the protocol. Path C uninstalls the BO and returns to the empty state 201. The path that the secure enclave 101 takes, i.e. the state that it switches to, can be determined by configuring the secure enclave 101, the contents of the installed BO and/or a command from the data processing circuit 103.

The internal architecture of the secure enclave 101, especially with regard to the AEAD module, is described in more detail below.

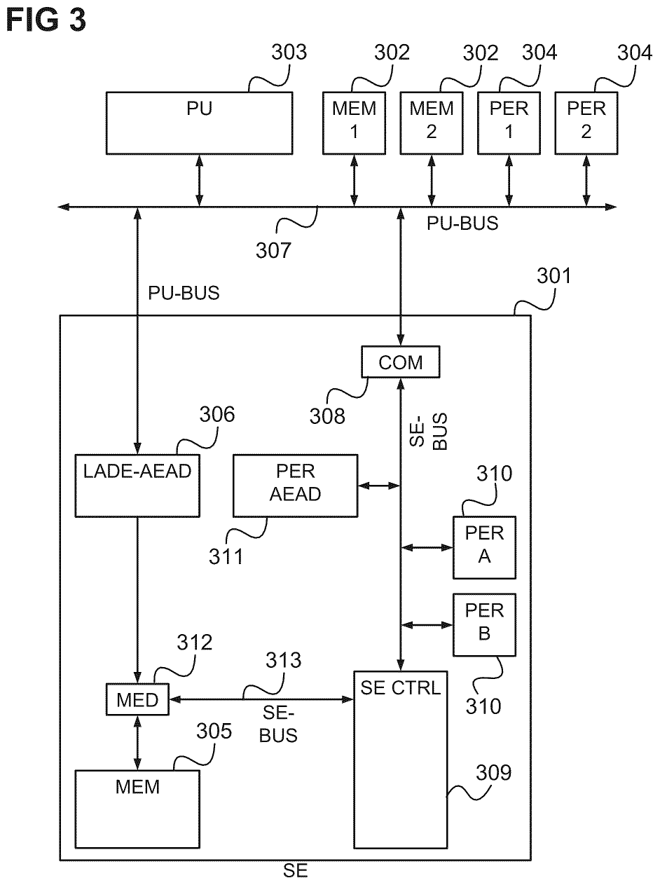

FIG. 3 shows a secure enclave 301 (corresponding to the secure enclave 101) in greater detail and illustrates how it communicates with a data processing circuit 303 (corresponding to the data processing circuit 103), one or more memories 302 (corresponding to the memory 102) and one or more peripheral devices 304 (corresponding to the one or more peripheral devices 104).

As described above, the hardware architecture of FIG. 3 (in particular the architecture of the secure enclave 301) makes it possible to download algorithms, e.g. in the form of executable program code with secrets (both together also referred to below as data to be protected), from the system domain to an (at least partially) volatile internal memory 305 of the secure enclave 301. Typically, the authenticity, confidentiality and integrity of these data to be protected should be ensured.

For this purpose, the secure enclave 301 includes an AEAD module 306, as mentioned above. The AEAD module 306 is connected to the memory 302 and the data processing circuit 303, for example via an interface provided in each case for this purpose (ICT-SE and ICT-MS), as shown in FIG. 1, or, as in the example of FIG. 3, by a processor unit bus (PU-BUS) 307 connecting the AEAD module 306, the memory 302 and the data processing circuit 303 to one another.

Since the AEAD module 306 in the example of FIG. 3 is provided for the purpose of loading program code (or generally the data to be protected) into the internal memory 305, it is also referred to as a loading AEAD module 306. The loading AEAD module 306 thus provides a mechanism for loading data (especially program code) from the system domain into the internal memory 305 of the secure enclave 301 and the means for authentication (A), authenticated encryption (AE) and/or authenticated encryption with associated data (AEAD).

It may optionally be provided that the data verified (in terms of authenticity and integrity) and decrypted by the loading AEAD module 306 are re-encrypted by a memory encryption/decryption unit (MED) 312 before being stored in the internal memory 305. As mentioned above, the internal memory may also contain non-volatile memory (e.g. an EEPROM or ReRAM memory) in addition to volatile memory (e.g. a RAM memory).

Furthermore, a communication interface 308 is provided (here also implemented by the PU-BUS 307) and is used for communication between the data processing circuit 303 and a security processor (e.g. controller (SE CTRL) of the secure enclave) 309. It is used, for example, to send inputs (e.g. input values for an algorithm) from the data processing circuit 303 to the secure enclave 301 and to send the results of the execution of algorithms (e.g. cryptographic calculations) from the secure enclave 301 to the data processing circuit 303.

Within the secure enclave 301, the internal memory 305 (which, as mentioned, can also consist of multiple memories of different types) contains program code that is executed on the security processor 309, as well as secret data (such as key material) and other data. Multiple peripheral devices (PER) 310, 311 are also provided in the secure enclave 301 and are connected to the security processor 309 via an internal bus system (SE-BUS) 313 which in this example also connects the security processor 309 to the internal memory 305. For example, the peripheral devices 310, 311 include multiple crypto accelerators, such as for symmetric algorithms (AES, DES, . . . ), hash functions (SHA, . . . ), and asymmetric cryptography (RSA, ECC, . . . ), in order to support various protocols, for example one-sided or mutual authentication, signature creation or verification, message authentication, generation of key streams, calculation of message authentication codes, and other common cryptographic services.

Some of these services require components that are also required for loading program code from the memory 302 into the internal memory 305 with AEAD, i.e. a functionality that is also provided by the loading AEAD module 306. Therefore, FIG. 3 illustrates a peripheral device (PER-AEAD) 311 which has essentially the same functionality as the module (loading AEAD) 306 used to download program code.

Various embodiments provide an approach that allows only a single AEAD module (instead of both a charging AEAD module 306 and a PER-AEAD module 311) to be used without compromising flexibility and security. This makes it possible to significantly reduce chip area and costs.

It should be noted that easy reuse of the AEAD module 306 for use by the security processor 309 (without further measures, as described below), however, would break the secure enclave paradigm, as it could, for example, open a direct path from the non-secure system domain to the internal memory 305 or to secret keys and data within the AEAD module 306.

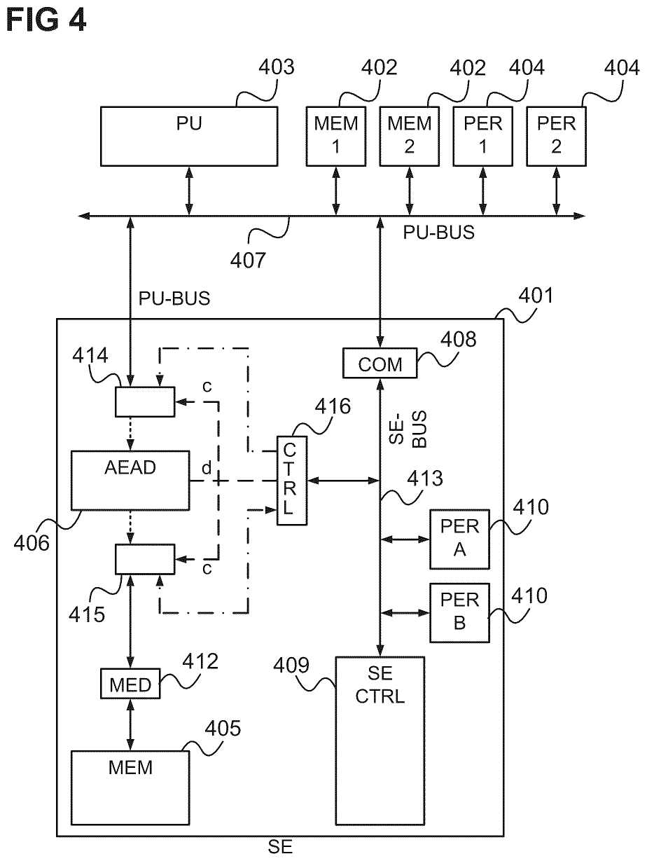

FIG. 4 shows an architecture with a secure enclave 401, a data processing circuit 403, one or more memories 402, and one or more peripheral devices 404, corresponding to the architecture of FIG. 3, with the difference that, instead of two AEAD modules 306, 311, only one AEAD module 406 (generally a crypto function circuit that provides cryptographic functions such as authentication, integrity checking and decryption, but does not necessarily work according to AEAD (but rather without “associated data”, for example)) is provided and is integrated into the secure enclave 401 such that it can be safely used in the set-up state 206 to download data (especially program code) from the system domain into the secure enclave 401 and then in the execution state 205 for one or more algorithms (e.g. calculations for cryptographic services) that are executed within the secure enclave 401. In FIG. 4, the solid, dotted, and dash-dotted lines indicate data paths and the dashed lines indicate control paths.

Path selection circuits 414, 415 (or “gate” circuits, e.g. in the form of multiplexers) controlled by a control unit 416 determine which data path or paths is/are open in a state and which data path or paths is/are closed in that state.

In the set-up state 206 (or at least partial states thereof, for which a path from the system domain through the AEAD module 406 to the internal memory 405 is required), the control unit 416 controls the path selection circuits 414, 415 such that the AEAD module 406 is connected to the data processing circuit 403 and the internal memory 405 (optionally via a memory encryption/decryption unit 412). This means that the path from the data processing circuit 403, via the first path selection circuit 414, the AEAD module 406, the second path selection circuit 415 and optionally the memory encryption/decryption unit 412, to the internal memory 405 (i.e. in particular the transitions between the paths indicated by solid and dotted lines) is open in the set-up state 206.

In the set-up state 206, the AEAD module 406 performs the data decryption, authentication, and integrity checking (test value, e.g. hash value or checksum check), as described above. In contrast, the data path between the security processor 409 and an internal memory 405 (i.e. the transitions between the paths indicated by the dash-dotted lines and the paths indicated by the dotted lines) is blocked in the set-up state 206 (or at least partial states thereof, for which a path from the system domain through the AEAD module 406 to the internal memory 405 is required). Since the security processor 409 can typically be trusted, this blocking is optional.

In the execution state 205, the required data (in particular the program code) are installed in the internal memory 405, with the result that one or more respective algorithms can now be executed by the security processor 409. In order to make it possible for the security processor 409 to use the AEAD module 406 for this purpose, the control unit 416 controls the path selection circuits 414, 415 such that, in the execution state 205, the path from the system domain to the AEAD module 406 via the first path selection circuit 414 (i.e. the transition between the paths indicated by solid and dotted lines at the first path selection circuit 414) is blocked, and, in contrast, the path from the security processor 409 to the AEAD module 406 or to the internal memory 405 (i.e., in particular, the transition between the paths indicated by the dash-dotted and the dotted line at the first path selection circuit 414 and the transition between the paths indicated by the dash-dotted and the solid and the dotted line at the second path selection circuit 415) is open. If the security processor 409 has its own connection to the internal memory 405 (e.g. via the SE-BUS 413), in the execution state 205, the connection from the security processor 409 via the second path selection circuit (i.e. the transition between the paths indicated by the solid and the dash-dotted line at the second path selection circuit 415) may also be blocked.

The path selection circuits 414, 415 together form a path selection circuit.

In order to meet the security requirements of the secure enclave 401, according to various embodiments, it is provided that.
The secure enclave 401 controls the state transitions between its states (not the “non-secure” data processing circuit 403 which can nevertheless indirectly trigger state transitions by way of commands)
In the set-up state, the unidirectional connection of data processing circuit 403->AEAD modules 406->internal memory 405 is established, with the result that data from the system domain can be decrypted and checked by the AEAD module 406 and stored in the internal memory 405. In addition, the path from the security processor 409 to the AEAD module 406 is then blocked (e.g. control signals c for the path selection circuits 414, 415 are “on”).
In the execution state, the path from the system domain (e.g. from the PU-BUS 407) to the internal memory 405 is blocked by the path selection circuits 414, 415 and the security processor 409 can use the now open data paths to the AEAD module 406 to feed data into the AEAD module 406 and retrieve the result of the calculations (e.g. control signals c for the path selection circuits 414, 415 are “off”).

The transitions between the execution state 205 and the set-up state 206 are security-critical in various embodiments, since the AEAD module 406 implements a state-dependent encryption algorithm and therefore contains a key and plain text data. Changing between use by the non-secure domain and the secure domain could therefore reveal the secret key and/or the plain text data to the non-secure domain. Therefore, the control unit (CTRL) 416 in accordance with various embodiments (e.g. by means of a control signal d) ensures that the current key and the data in the AEAD module 406 are deleted when the domain is changed, i.e. when the path selection circuits 414, 415 are switched. This can be achieved by overwriting the key or the data with constants or random values, or by ensuring that they are always overwritten with a corresponding new key or new data before an operation is started.

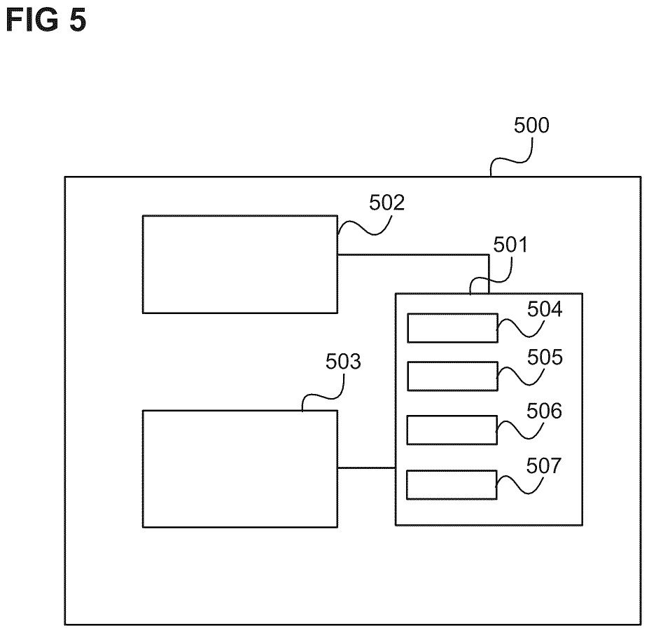

In summary, various embodiments provide an electronic data processing device as illustrated in FIG. 5.

FIG. 5 shows an electronic data processing device 500 according to one embodiment.

The electronic data processing device 500 has a (e.g. non-secure, “first”) memory 502 configured to store encrypted program code for a cryptographic algorithm (e.g. together with application-specific data such as keys, identifications, certificates) (i.e. to store program code in encrypted form).

The electronic data processing device 500 further comprises a cryptoprocessor unit 501 having an internal (e.g. secure, “second”) volatile memory 504, an interface to the (first) memory 502, a security processor 505 and a crypto function circuit 506.

The electronic data processing device 500 further comprises a data processing circuit 503 having an interface to the cryptoprocessor unit 501.

The cryptoprocessor unit 501 is configured
in a configuration state, to receive the encrypted program code from the memory, to decrypt it by means of the crypto function circuit 506 and to verify the integrity and/or authenticity of the decrypted program code and to store it in the internal volatile memory 504;
in an execution state, to execute the decrypted program code by means of the security processor 505 and at least partially by means of the crypto function circuit 506.

The electronic data processing device 500 (e.g. the cryptoprocessor unit 501) further comprises a path selection circuit 507 which is configured, in the configuration state, to provide a first data path from the (first) memory 502, via the crypto function circuit 506, to the internal volatile memory 504 of the cryptoprocessor unit 501 and, in the execution state, to interrupt the first data path and to provide a second data path between the security processor 505 and the internal volatile memory 504 and the crypto function circuit 506.

According to various embodiments, a cryptoprocessor unit (e.g. a secure enclave or part of a secure enclave) offers multiple paths that allow the use of a cryptoprocessor unit 501 both when installing program code on the cryptoprocessor unit 501 and when executing it, without compromising security.

The cryptoprocessor unit may be a (or at least a part of a) secure enclave at least partially implemented in hardware, e.g. as part of a system such as a microcontroller or microprocessor system which has multiple (other) hardware components (which, for example, implement the memory and the data processing circuit (e.g. a processor)).

Various exemplary embodiments are indicated below.

Exemplary embodiment 1 is an electronic data processing device comprising a memory configured to store encrypted program code for a cryptographic algorithm, a cryptoprocessor unit having a security processor, an interface to the memory, an internal volatile memory and a crypto function circuit, a data processing circuit having an interface to the cryptoprocessor unit, wherein the cryptoprocessor unit is configured,
in a configuration state, to receive the encrypted program code from the memory, to decrypt it by means of the crypto function circuit and to verify the integrity and/or authenticity of the decrypted program code and to store it in the internal volatile memory;
in an execution state, to execute the decrypted program code by means of the security processor and at least partially by means of the crypto function circuit; and
   a path selection circuit which is configured, in the configuration state, to provide a first data path from the memory, via the crypto function circuit, to the internal volatile memory of the cryptoprocessor unit and, in the execution state, to interrupt the first data path and to provide a second data path between the security processor and the internal volatile memory and the crypto function circuit.

Exemplary embodiment 2 is an electronic data processing device according to exemplary embodiment 1, wherein the path selection circuit is configured to interrupt the second data path in the configuration state.

Exemplary embodiment 3 is an electronic data processing device according to exemplary embodiment 1 or 2, wherein the security processor has no read access and no write access to the internal volatile memory in the configuration state.

Exemplary embodiment 4 is an electronic data processing device according to any one of exemplary embodiments 1 to 3, wherein the first data path is unidirectional.

Exemplary embodiment 5 is an electronic data processing device according to any one of exemplary embodiments 1 to 4, wherein the security processor has no access to the crypto function circuit in the configuration state.

Exemplary embodiment 6 is an electronic data processing device according to any one of exemplary embodiments 1 to 4, wherein the data processing circuit has no access to the crypto function circuit and the internal volatile memory of the cryptoprocessor unit in the execution state.

Exemplary embodiment 7 is an electronic data processing device according to any one of exemplary embodiments 1 to 6, wherein the path selection circuit has a first path selection circuit which is configured to establish a connection between the data processing circuit and the crypto function circuit in the configuration state and to block it in the execution state.

Exemplary embodiment 8 is an electronic data processing device according to exemplary embodiment 7, wherein the path selection circuit has a second path selection circuit which is configured to establish a connection between the security processor and the crypto function circuit in the execution state and to block it in the configuration state.

Exemplary embodiment 9 is an electronic data processing device according to exemplary embodiment 8, wherein the path selection circuit is configured to establish a connection between the crypto function circuit and the internal volatile memory in the execution state.

Exemplary embodiment 10 is an electronic data processing device according to any one of exemplary embodiments 1 to 9, wherein the memory is configured to store a test value of the decrypted program code and the cryptoprocessor unit is configured to verify the integrity and/or authenticity of the decrypted program code based on the test value.

Exemplary embodiment 11 is an electronic data processing device according to any one of exemplary embodiments 1 to 10, wherein the crypto function circuit is an authenticated encryption module or an authenticated encryption with associated data module.

Exemplary embodiment 12 is an electronic data processing device according to any one of exemplary embodiments 1 to 11, wherein the cryptoprocessor unit belongs to a first area of the data processing device which is more strongly protected against physical attacks than a second area, to which the data processing circuit and the memory belong.

Exemplary embodiment 13 is an electronic data processing device according to any one of exemplary embodiments 1 to 12, wherein the cryptoprocessor unit is a secure enclave of the electronic data processing device.

Further exemplary embodiments 14 to 27 are indicated below and may be provided alternatively or in combination with the above exemplary embodiments 1 to 13 (i.e. it is possible to provide in particular an electronic data processing device which has the features of one of exemplary embodiments 1 to 13 and the features of one of exemplary embodiments 14 to 27).

Exemplary embodiment 14 is an electronic data processing device comprising a memory configured to store encrypted program code for a cryptographic algorithm in encrypted form, a cryptoprocessor unit having an internal volatile memory and an interface to the memory, wherein the cryptoprocessor unit is configured to change between predefined states and has a key memory area which stores first key information, a data processing circuit having an interface to the cryptoprocessor unit, wherein the cryptoprocessor unit is configured,
in an initial state, to wait for second key information from the data processing circuit, which allows the cryptoprocessor unit to derive a key for decrypting the encrypted program code by combining the first key information with the second key information;
in a key loading state, to receive the second key information from the data processing circuit;
in an install state, to receive the encrypted program code from the memory, to decrypt it by means of the key, to verify the integrity and/or authenticity of the decrypted program code and to store it in the internal volatile memory;
in an execution state, to execute the decrypted program code; and after one or more executions of the decrypted program code, to purge the internal volatile memory of the decrypted program code and to return to the initial state.

Exemplary embodiment 15 is an electronic data processing device according to exemplary embodiment 14, wherein the cryptoprocessor unit is configured to purge the internal volatile memory of the decrypted program code in response to a reset command from the data processing circuit and to return to the initial state.

Exemplary embodiment 16 is an electronic data processing device according to exemplary embodiment 14 or 15, wherein the cryptoprocessor unit is configured to purge the internal volatile memory of the decrypted program code after a number of executions of the decrypted program code specified in the memory for the decrypted program code and to return to the initial state.

Exemplary embodiment 17 is an electronic data processing device according to any one of exemplary embodiments 14 to 16, wherein the cryptoprocessor unit is configured to switch to a ready state after decrypting the encrypted program code and verifying the integrity and/or authenticity of the decrypted program code, in which state it waits for an execution command from the data processing circuit and switches to the execution state in response to the execution command.

Exemplary embodiment 18 is an electronic data processing device according to exemplary embodiment 17, wherein the cryptoprocessor unit is configured to return to the ready state after each execution of the decrypted program code.

Exemplary embodiment 19 is an electronic data processing device according to any one of exemplary embodiments 14 to 18, wherein the cryptoprocessor unit is configured to return to the install state after one or more executions of the decrypted program code and to receive encrypted further program code from the memory, to decrypt it by means of a further key, to verify its integrity and/or authenticity and to store it in the internal volatile memory and to execute it in the execution state.

Exemplary embodiment 20 is an electronic data processing device according to any one of exemplary embodiments 14 to 19, wherein the cryptoprocessor unit is a secure enclave of the electronic data processing device.

Exemplary embodiment 21 is an electronic data processing device according to any one of exemplary embodiments 14 to 20, wherein the cryptoprocessor unit has a non-volatile memory with the key memory area.

Exemplary embodiment 22 is an electronic data processing device according to any one of exemplary embodiments 14 to 21, wherein the memory is configured to store a test value of the program code and the cryptoprocessor unit is configured to verify the integrity and/or authenticity of the received program code based on the test value.

Exemplary embodiment 23 is an electronic data processing device according to any one of exemplary embodiments 14 to 22, wherein the internal volatile memory is empty in the initial state.

Exemplary embodiment 24 is an electronic data processing device according to any one of exemplary embodiments 14 to 23, wherein the first key information is a physically unclonable function value.

Exemplary embodiment 25 is an electronic data processing device according to any one of exemplary embodiments 14 to 24, wherein the second key information is a key modification value for the first key information.

Exemplary embodiment 26 is an electronic data processing device according to any one of exemplary embodiments 14 to 25, wherein the cryptoprocessor unit is configured, when the verification of the received program code fails, to delete the received program code from its internal volatile memory and to switch to the initial state or an error state.

Exemplary embodiment 27 is an electronic data processing device according to any one of exemplary embodiments 14 to 26, wherein the cryptoprocessor unit belongs to an area of the data processing device which is more strongly protected against physical attacks than an area, to which the data processing circuit and the memory belong.

Although the invention has been shown and described in particular with reference to certain embodiments, it should be understood by those familiar with the field that numerous changes in terms of design and details can be made to it, without departing from the nature and scope of the invention, as defined by the following claims. The scope of the invention is therefore determined by the appended claims, and the intention is for all changes falling within the meaning or scope of equivalence of the claims to be included.

1. An electronic data processing device comprising:
a memory configured to store encrypted program code for a cryptographic algorithm;
a cryptoprocessor unit having a security processor, an interface to the memory, an internal volatile memory and a crypto function circuit;
a data processing circuit having an interface to the cryptoprocessor unit;
wherein the cryptoprocessor unit is configured,
in a configuration state, to receive the encrypted program code from the memory, to decrypt it by means of the crypto function circuit and to verify the integrity and/or authenticity of the decrypted program code and to store it in the internal volatile memory;
in an execution state, to execute the decrypted program code by means of the security processor and at least partially by means of the crypto function circuit; and
a path selection circuit which is configured, in the configuration state, to provide a first data path from the memory, via the crypto function circuit, to the internal volatile memory of the cryptoprocessor unit and, in the execution state, to interrupt the first data path and to provide a second data path between the security processor and the internal volatile memory and the crypto function circuit.

2. The electronic data processing device as claimed in claim 1, wherein the path selection circuit is configured to interrupt the second data path in the configuration state.

3. The electronic data processing device as claimed in claim 1, wherein the security processor has no read access and no write access to the internal volatile memory in the configuration state.

4. The electronic data processing device as claimed in claim 1, wherein the first data path is unidirectional.

5. The electronic data processing device as claimed in claim 1, wherein the security processor has no access to the crypto function circuit in the configuration state.

6. The electronic data processing device as claimed in claim 1, wherein the data processing circuit has no access to the crypto function circuit and the internal volatile memory of the cryptoprocessor unit in the execution state.

7. The electronic data processing device as claimed in claim 1,
wherein the path selection circuit has a first path selection circuit which is configured to establish a connection between the data processing circuit and the crypto function circuit in the configuration state and to block it in the execution state.

8. The electronic data processing device as claimed in claim 7, wherein the path selection circuit has a second path selection circuit which is configured to establish a connection between the security processor and the crypto function circuit in the execution state and to block it in the configuration state.

9. The electronic data processing device as claimed in claim 8, wherein the path selection circuit is configured to establish a connection between the crypto function circuit and the internal volatile memory in the execution state.

10. The electronic data processing device as claimed in claim 1, wherein the memory is configured to store a test value of the decrypted program code and the cryptoprocessor unit is configured to verify the integrity and/or authenticity of the decrypted program code based on the test value.

11. The electronic data processing device as claimed in claim 1, wherein the crypto function circuit is an authenticated encryption module or an authenticated encryption with associated data module.

12. The electronic data processing device as claimed in claim 1, wherein the cryptoprocessor unit belongs to a first area of the data processing device which is more strongly protected against physical attacks than a second area, to which the data processing circuit and the memory belong.

13. The electronic data processing device as claimed in claim 1, wherein the cryptoprocessor unit is a secure enclave of the electronic data processing device.
